(19) United States
(12) Patent Application Publication
(10) Pub. No.: US 2026/0188188 A1
(43) Pub. Date: Jul. 2, 2026

(54) DISPLAY DEVICE

(71) Applicant: LG Display Co., Ltd., Seoul (KR)

(72) Inventors: SeungHo HEO, Paju-si (KR); KiBok PARK, Paju-si (KR)

(73) Assignee: LG Display Co., Ltd., Seoul (KR)

(21) Appl. No.: 19/317,719

(22) Filed: Sep. 3, 2025

(30) Foreign Application Priority Data
Dec. 31, 2024 (KR) 10-2024-0201658

(51) Int. Cl. G09G 3/32

(52) U.S. Cl. CPC G09G 3/32; G09G 2300/0819; G09G 2300/0852; G09G 2300/0861; G09G 2310/0267; G09G 2310/0286; G09G 2310/08; G09G 2330/021

(57) ABSTRACT

The present disclosure provides a display device that includes a gate driving circuit configured to generate a first light control signal and a second light control signal in an integrated manner, and is capable of reducing the size of a bezel.

### CROSS REFERENCE TO RELATED APPLICATION

This application claims priority from Korean Patent Application No. 10-2024-0201658, filed on Dec. 31, 2024, in the Korean Intellectual Property Office, which is hereby incorporated by reference for all purposes as if fully set forth herein.

### TECHNICAL FIELD

The present disclosure relates to electronic devices, and more specifically, to display devices.

### BACKGROUND

As the information society continues to advance, demand for display devices used to present visual content has been increasing in various forms. In recent years, a wide range of display devices, such as liquid crystal display (LCD) devices and organic light-emitting display (OLED) devices, have been utilized.

A display device may include a display panel in which a plurality of subpixels are arranged. A plurality of signal wires may be disposed on the display panel to drive the subpixels. For example, signal wires such as data lines, scan signal lines, and emission signal control lines may be provided.

A data driving circuit may supply signals to the data lines.

A gate driving circuit may supply signals to the scan signal lines and the emission signal control lines.

### SUMMARY

One or more aspects of the present disclosure may provide a display device capable of reducing the size of the bezel by employing a novel gate driving circuit.

One or more aspects of the present disclosure may provide a display device capable of simultaneously generating a first light control signal and a second light control signal by employing a novel gate driving circuit.

One or more aspects of the present disclosure may provide a display device capable of operating with low power consumption by employing a novel gate driving circuit.

Aspects, examples, and embodiments provided in the present disclosure are not limited to the foregoing description, and additional aspects, examples, and embodiments provided in the present disclosure will become apparent to those skilled in the art from the following description.

According to one or more example embodiments of the present disclosure, a display device comprising: a first subpixel located in a display area and including a light-emitting element, a first light emission control signal line electrically connected to the first subpixel and supplying a first light control signal for controlling the light emission timing of the light-emitting element, a second light emission control signal line electrically connected to the first subpixel and supplying a second light control signal for controlling the light emission timing of the light-emitting element, and a gate driving circuit supplying the first light control signal to the first light emission control signal line and the second light control signal to the second light emission control signal line. The gate driving circuit may include: a logic unit controlling the voltage states of a Q node and a QB node, and a signal output unit outputting a signal whose voltage level varies depending on the voltage states of the Q node and the QB node. The signal output unit may include: a first light-emitting signal output transistor controlled by the voltage state of the Q node, a second light-emitting signal output transistor controlled by the voltage state of the QB node and electrically connected to the first light-emitting signal output transistor at a connection node, and an emission signal generation circuit that is electrically connected to the first and second light-emitting signal output transistors at the connection node, receives an input voltage, and outputs, based on the input voltage, the first light control signal to the first light emission control signal line and the second light control signal to the second light emission control signal line.

According to one or more aspects of the present disclosure, a display device capable of reducing the size of the bezel by employing a novel gate driving circuit.

According to one or more aspects of the present disclosure, a display device capable of simultaneously generating a first light control signal and a second light control signal by employing a novel gate driving circuit.

According to one or more aspects of the present disclosure, a display device capable of operating with low power consumption by employing a novel gate driving circuit.

Effects or advantages from aspects, examples, and embodiments described herein are not limited thereto, and additional effects or advantages will become apparent to those skilled in the art from the following description.

### BRIEF DESCRIPTION OF THE DRAWINGS

The accompanying drawings, which are included to provide a further understanding of the disclosure and are incorporated in and constitute a part of the disclosure, illustrate aspects of the disclosure and together with the description serve to explain principles of the disclosure. It should be therefore understood that aspects, examples, and embodiments described herein are not limited to the illustrations of the accompanying drawings. In the drawings:

FIG. 1 illustrates an example system configuration of a display device according to aspects of the present disclosure;

FIG. 2 illustrates an example equivalent circuit of a subpixel included in the display device according to aspects of the present disclosure;

FIG. 3 illustrates an example driving timing diagram of the subpixel according to aspects of the present disclosure;

FIG. 4 illustrates an example diagram related to a gate driving circuit and a subpixel according to aspects of the present disclosure;

FIG. 5 illustrates an example circuit diagram related to a second drive unit according to aspects of the present disclosure;

FIG. 6 illustrates an example diagram related to an emission signal generation circuit according to aspects of the present disclosure;

FIGS. 7 to 12 illustrate example driving timing diagrams of the emission signal generation circuit according to aspects of the present disclosure;

FIG. 13 illustrates an example diagram related to a gate driving circuit and a subpixel according to aspects of the present disclosure;

FIG. 14 illustrates an example circuit diagram related to a second drive unit according to aspects of the present disclosure.

### DETAILED DESCRIPTION

Reference will now be made in detail to example embodiments of the present disclosure, examples of which may be illustrated in the accompanying drawings. In the following description, the structures, embodiments, implementations, methods and operations described herein are not limited to the specific example or examples set forth herein and may be changed as is known in the art, unless otherwise specified. Like reference numerals designate like elements throughout, unless otherwise specified. Names of the respective elements used in the following explanations are selected only for convenience of writing the specification and may thus be different from those used in actual products. Advantages and features of the present disclosure, and implementation methods thereof will be clarified through following example embodiments described with reference to the accompanying drawings. The present disclosure may, however, be embodied in different forms and should not be construed as limited to the example embodiments set forth herein. Rather, these example embodiments are provided so that this disclosure may be sufficiently thorough and complete to assist those skilled in the art to fully understand the scope of the present disclosure. Further, the protection scope of the present disclosure is defined by claims and their equivalents. In the following description, where the detailed description of the relevant known function or configuration may unnecessarily obscure aspects of the present disclosure, a detailed description of such known function or configuration may be omitted. The shapes, sizes, ratios, angles, numbers, and the like, which are illustrated in the drawings to describe various example embodiments of the present disclosure, are merely given by way of example. Therefore, the present disclosure is not limited to the illustrations in the drawings. The terms such as “including,” “having,” “containing,” “constituting” “make up of,” and “formed of” used herein are generally intended to allow other components to be added unless the terms are used with the term “only.” As used herein, singular forms are intended to include plural forms unless the context clearly indicates otherwise.

Although the terms “first,” “second,” A, B, (a), (b), and the like may be used herein to describe various elements, these elements should not be interpreted to be limited by these terms as they are not used to define a particular order or precedence. These terms are used only to distinguish one element from another. For example, a first element could be termed a second element, and, similarly, a second element could be termed a first element, without departing from the scope of the present disclosure.

When it is mentioned that a first element “is connected or coupled to,” “contacts,” “overlaps with,” or the like a second element, it should be interpreted that, not only can the first element “be directly connected or coupled to,” “directly contact,” or “directly overlap with” the second element, but a third element can also be “interposed” between the first and second elements, or the first and second elements can “be connected or coupled to,” “contact,” “overlap with,” or the like each other via a fourth element. Here, the second element may be included in at least one of two or more elements that “are connected or coupled to,” “contact,” “overlap with,” or the like each other.

Where positional relationships are described, for example, where the positional relationship between two parts is described using “on,” “over,” “under,” “above,” “below,” “beside,” “next,” or the like, one or more other parts may be located between the two parts unless a more limiting term, such as “immediate(ly),” “direct(ly),” or “close(ly)” is used. For example, where an element or layer is disposed “on” another element or layer, a third element or layer may be interposed therebetween. Furthermore, the terms “left,” “right,” “top,” “bottom, “downward,” “upward,” “upper,” “lower,” and the like refer to an arbitrary frame of reference.

In addition, when any dimensions, relative sizes, and the like are mentioned, it should be considered that numerical values for an elements or features, or corresponding information (e.g., level, range, and the like) include a tolerance or error range that may be caused by various factors (e.g., process factors, internal or external impact, noise, and the like) even when a relevant description is not specified. Further, the term “may” fully encompasses all the meanings of the term “can”.

In the following description, various example aspects of the present disclosure are described in detail with reference to the accompanying drawings. With respect to reference numerals to elements of each of the drawings, the same elements may be illustrated in other drawings, and like reference numerals may refer to like elements unless stated otherwise. The same or similar elements may be denoted by the same reference numerals even though they are depicted in different drawings. In addition, for convenience of description, a scale, dimension, size, and thickness of each of the elements illustrated in the accompanying drawings may be different from an actual scale, dimension, size, and thickness, and thus, aspects of the present disclosure are not limited to a scale, dimension, size, and thickness illustrated in the drawings.

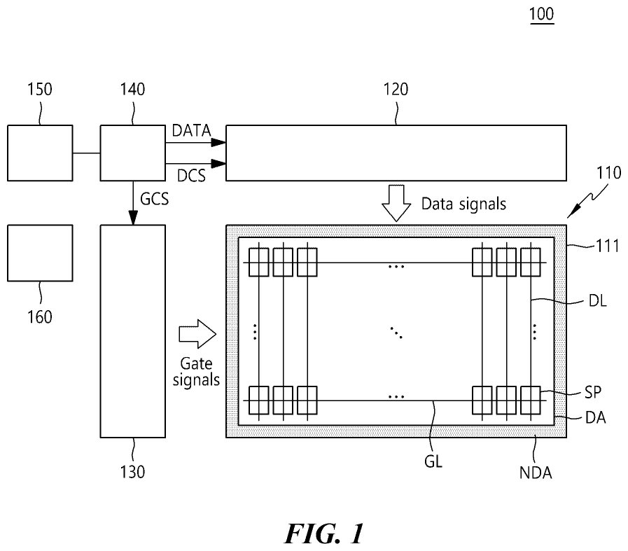

FIG. 1 illustrates a system configuration of a display device 100 according to embodiments of the present disclosure. All components of each display device according to all aspects of the present disclosure are operatively coupled and configured.

Referring to FIG. 1, the display device 100 may include a display panel 110 and a display driving circuit as components for displaying an image. The display driving circuit may include a data driving circuit 120, a gate driving circuit 130, and a display controller 140. These components are configured to drive the display panel 110.

The display panel 110 may include a substrate 111 and a plurality of subpixels SP disposed on the substrate 111.

The substrate 111 of the display panel 110 may include a display area DA in which an image may be displayed, and a non-display area NDA surrounding the display area DA.

A plurality of subpixels SP for displaying an image may be disposed in the display area DA, and the non-display area NDA may include a pad area located in a first direction from the display area DA.

The non-display area NDA of the display panel 110 may be very narrow in size. In the present disclosure, the non-display area NDA may also be referred to as a “bezel.”

Various types of signal lines may be disposed on the substrate 111 of the display panel 110 to drive the plurality of subpixels SP.

The display device 100 may be a liquid crystal display device or a self-emissive display device in which the display panel 110 emits light by itself. When the display device 100 is a self-emissive display device, each of the subpixels SP may include a light emitting element.

The structure of each subpixel SP may vary depending on the type of the display device 100. For example, when the display device 100 is a self-emissive display device in which the subpixels SP emit light on their own, each subpixel SP may include a light emitting element, one or more transistors, and one or more capacitors.

Various types of signal lines may include a plurality of data lines DL for transmitting data signals (also referred to as data voltages or image signals), and a plurality of gate lines GL for transmitting gate signals (also referred to as scan signals).

The data driving circuit 120 may be a circuit configured to drive the plurality of data lines DL, and may output data signals to the plurality of data lines DL.

The data driving circuit 120 may receive digital image data DATA from the display controller 140, convert the received digital image data into analog data signals, and output the analog data signals to the plurality of data lines DL.

The data driving circuit 120 may be disposed to the outer region of the display area DA of the display panel 110, but alternatively may be disposed within the display area DA.

The gate driving circuit 130 may be a circuit configured to drive the plurality of gate lines GL, and may output gate signals to the plurality of gate lines GL.

The gate driving circuit 130 may receive various gate control signals GCS, a first gate voltage corresponding to a turn-on level, and a second gate voltage corresponding to a turn-off level, to generate gate signals and supply the generated gate signals to the plurality of gate lines GL.

In embodiments of the present disclosure, the gate driving circuit 130 may be implemented as a gate-in-panel type and may be embedded in the display panel 110. In such a case, the gate driving circuit 130 may be formed on the substrate 111 during the manufacturing process of the display panel 110.

The gate driving circuit 130 may be disposed within the display area DA of the display panel 110. For example, the gate driving circuit 130 may be disposed in a first partial region (e.g., a left or right side) of the display area DA. In another example, the gate driving circuit 130 may be disposed in both a first partial region and a second partial region (e.g., left and right sides) of the display area DA.

In the present disclosure, a gate driving circuit 130 embedded in the display panel 110 as a gate-in-panel type may be referred to as a “gate-in-panel circuit.”

The display controller 140 may control the data driving circuit 120 and the gate driving circuit 130, and may manage driving timings of the data lines DL and the gate lines GL.

The display controller 140 may supply a data driving control signal DCS to the data driving circuit 120 and a gate driving control signal GCS to the gate driving circuit 130.

The display controller 140 may receive input image data from a host system 150 and supply image data DATA to the data driving circuit 120 based on the input image data.

The display controller 140 may be implemented as a separate component from the data driving circuit 120, or may be integrated with the data driving circuit 120 into a single integrated circuit.

As shown in FIG. 1, a memory 160 may be electrically connected to the driving circuits 120 and 130 and the display controller 140. The memory 160 may store various types of information necessary for driving the display panel 110, such as image quality enhancement data. The memory 160 may store pre-stored information, or may store data received from the display controller 140 before the display device 100 is completely powered off.

The display device 100 may further include a touch sensor and a touch sensing circuit to support touch sensing functionality. The touch sensing circuit may detect whether a touch event has occurred by a touch object such as a finger or pen, or detect the touch location.

The touch sensing circuit may perform sensing based on a self-capacitance or mutual-capacitance sensing method.

The display device 100 according to embodiments of the present disclosure may be a mobile terminal such as a smartphone or tablet, or a monitor or television (TV) of various sizes. However, the display device 100 is not limited thereto and may include various types and sizes of display devices capable of displaying information or images.

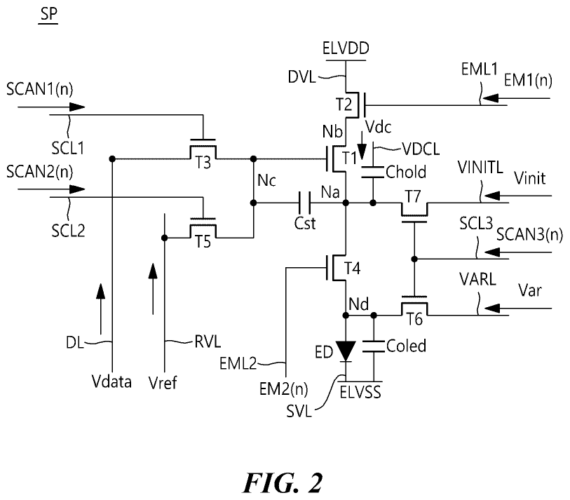

FIG. 2 is an equivalent circuit of a subpixel SP according to embodiments of the present disclosure.

Referring to FIG. 2, the subpixel SP may include a plurality of transistors, a plurality of capacitors, and a light emitting element ED.

Referring to FIG. 2, the first transistor T1 may be electrically connected between a first pixel node Ta and a second pixel node Tb. The gate node of the first transistor T1 may be electrically connected to a third pixel node Tc. The first transistor T1 may be controlled by the voltage state of the third pixel node Tc. The first transistor T1 may allow a driving current to flow from the second pixel node Tb toward the first pixel node Ta.

Referring to FIG. 2, the second transistor T2 may be electrically connected between the first pixel node Ta and the driving voltage line DVL. The gate node of the second transistor T2 may be electrically connected to the first light emission control signal line EML1. The second transistor T2 may be controlled by the first light control signal EM1n.

Referring to FIG. 2, the third transistor T3 may be electrically connected between the third pixel node Tc and the data line DL. The gate node of the third transistor T3 may be electrically connected to the first scan signal line SCL1. The third transistor T3 may be controlled by the first scan signal SCAN1n.

Referring to FIG. 2, the fourth transistor T4 may be electrically connected between the first pixel node Ta and a fourth pixel node Td. The gate node of the fourth transistor T4 may be electrically connected to the second light emission control signal line EML2. The fourth transistor T4 may be controlled by the second light control signal EM2n.

Referring to FIG. 2, the fifth transistor T5 may be electrically connected between the third pixel node Tc and the reference voltage line RVL. The gate node of the fifth transistor T5 may be electrically connected to the second scan signal line SCL2. The fifth transistor T5 may be controlled by the second scan signal SCAN2n. When the fifth transistor T5 is turned on, the reference voltage Vref may be supplied to the third pixel node Tc.

Referring to FIG. 2, the sixth transistor T6 may be electrically connected between the fourth pixel node Td and the reset voltage line VARL. The gate node of the sixth transistor T6 may be electrically connected to the third scan signal line SCL3. The sixth transistor T6 may be controlled by the third scan signal SCAN3n. When the sixth transistor T6 is turned on, the reset voltage Var may be supplied to the fourth pixel node Td.

Referring to FIG. 2, the seventh transistor T7 may be electrically connected between the first pixel node Ta and the initialization voltage line VINITL. The gate node of the seventh transistor T7 may be electrically connected to the third scan signal line SCL3. The seventh transistor T7 may be controlled by the third scan signal SCAN3n. When the seventh transistor T7 is turned on, the initialization voltage Vinit may be supplied to the first pixel node Ta.

Referring to FIG. 2, the first capacitor Cst may be electrically connected between the first pixel node Ta and the third pixel node Tc. The first capacitor Cst may be a capacitor that stores voltage for driving the light emitting element ED.

Referring to FIG. 2, the second capacitor Chold may be electrically connected between the first pixel node Ta and the DC voltage line VDCL. The second capacitor Chold may be a capacitor that can increase the range of the driving current for the light emitting element ED.

The light emitting element ED may be electrically connected between the fourth pixel node Td and the base voltage line SVL. The base voltage line SVL may supply the base voltage ELVSS to the cathode of the light emitting element ED. The light emitting element ED may emit light corresponding to the driving current. Since the light emitting element ED has diode characteristics, a parasitic capacitor Coled may be formed across the light emitting element ED.

The first transistor T1 to the seventh transistor T7 may all be negative-type transistors. That is, the first transistor T1 to the seventh transistor T7 may be N-type transistors. Each of the first transistor T1 to the seventh transistor T7 may include an oxide semiconductor.

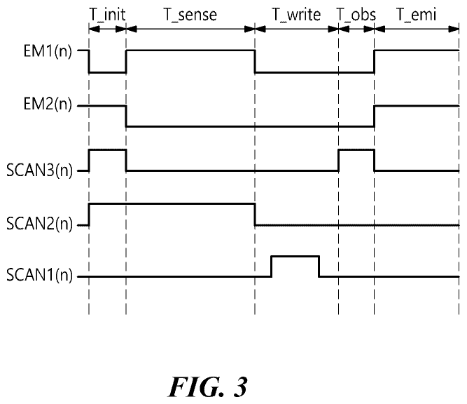

FIG. 3 is a timing diagram of the subpixel SP according to embodiments of the present disclosure.

Referring to FIG. 3, the driving period of the subpixel SP may include an initialization period T_init, a sensing period T_sense, a data writing period T_write, a bias period T_obs, and an emission period T_emi.

The initialization period T_init may be a period for initializing the first capacitor Cst and the second capacitor Chold. During the initialization period T_init, the fourth transistor T4, the fifth transistor T5, the sixth transistor T6, and the seventh transistor T7 may be turned on. During the initialization period T_init, the initialization voltage Vinit may be supplied to the first pixel node Ta, a reset voltage Var may be supplied to the fourth pixel node Td, and a reference voltage Vref may be supplied to the third pixel node Tc.

The sensing period T_sense may be a period in which the characteristics of the first transistor T1 are reflected in the first capacitor Cst and the second capacitor Chold. During the sensing period T_sense, the first transistor T1, the second transistor T2, and the fifth transistor T5 may be turned on. The driving voltage ELVDD may be supplied to the second pixel node Tb, and during this time, the first transistor T1 may flow a sensing current to the first pixel node Ta. The second capacitor Chold may store a voltage corresponding to the voltage difference between the first pixel node Ta and the direct current voltage line VDCL.

The data writing period T_write may be a period in which the data voltage Vdata is supplied to the subpixel SP. During the data writing period T_write, the third transistor T3 may be turned on. The data voltage Vdata may be supplied through the data line DL and delivered to the third pixel node Tc.

The bias period T_obs may be a period for supplying specific voltages to the anode of the light emitting element ED and to the electrodes of the first capacitor Cst and the second capacitor Chold. During the bias period T_obs, the sixth transistor T6 and the seventh transistor T7 may be turned on.

The emission period T_emi may be a period in which the light emitting element ED emits light. During the emission period T_emi, the first transistor T1, the second transistor T2, and the fourth transistor T4 may be turned on. During the emission period T_emi, the first transistor T1 may supply a driving current to the light emitting element ED. The light emitting element ED may emit light corresponding to the driving current.

The scan signals SCAN1n, SCAN2n, SCAN3n and the emission control signals EM1n, EM2n may be generated by the gate driving circuit 130 and supplied to the subpixel SP. The following describes these signals in detail.

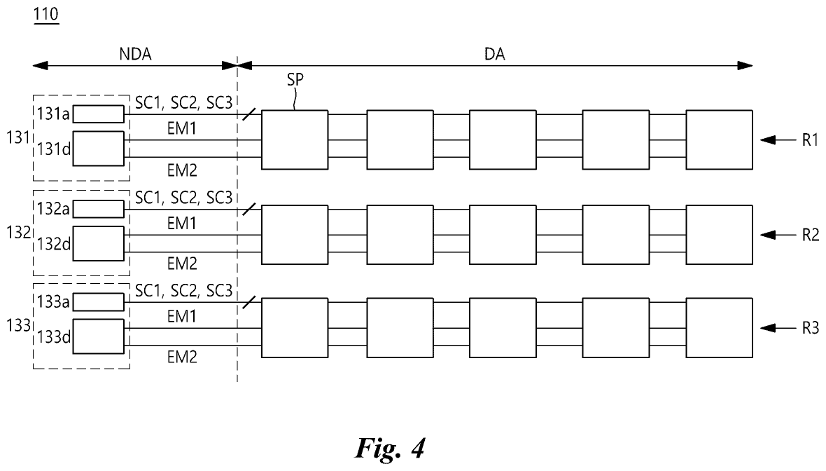

FIG. 4 is a diagram illustrating a gate driving circuit 130 and subpixels SP according to embodiments of the present disclosure.

Referring to FIG. 4, a plurality of subpixels SP may be arranged in a display area DA. The gate driving circuit 130 may be disposed in a non-display area NDA. The gate driving circuit 130 may supply signals to the plurality of subpixels SP arranged in the display area DA. The gate driving circuit 130 may supply a first light control signal EM1, a second light control signal EM2, a first scan signal SCAN1, a second scan signal SCAN2, and a third scan signal SCAN3 to the subpixels SP.

The gate driving circuit 130 may include a plurality of stage circuits 131, 132, and 133. For example, a stage circuit disposed in a first row R1 may be a first stage circuit 131. A stage circuit disposed in a second row R2 may be a second stage circuit 132. A stage circuit disposed in a third row R3 may be a third stage circuit 133.

The first stage circuit 131 may supply signals to the subpixels SP disposed in the first row R1. The second stage circuit 132 may supply signals to the subpixels SP disposed in the second row R2. The third stage circuit 133 may supply signals to the subpixels SP disposed in the third row R3.

Each of the plurality of stage circuits 131, 132, and 133 may include a first drive unit 131a and a second drive unit 131d.

The first drive unit 131a may be a circuit configured to output the first scan signal SCAN1, the second scan signal SCAN2, and the third scan signal SCAN3. The second drive unit 131d may be a circuit configured to output the first light control signal EM1 and the second light control signal EM2.

The second drive units 131d disposed in a plurality of rows may be electrically connected to each other. For example, the second drive unit 131d disposed in the second row R2 may be electrically connected to the second drive units 131d of the first row R1 and the third row R3. That is, the second drive unit 131d of the n-th row may be electrically connected to the second drive units 131d of the (n+1)-th row and the (n−1)-th row, where n is a natural number equal to or greater than 2.

Since the second drive units 131d disposed in the plurality of rows may exchange signals with each other, the second drive units 131d may be sequentially driven. For example, after the second drive unit 131d in the first row R1 outputs a signal, it may supply a specific signal to the second drive unit 131d in the second row R2. After the second drive unit 131d in the second row R2 outputs a signal, it may supply a specific signal to the second drive unit 131d in the third row R3. For example, the specific signal mentioned above may be a setting signal, a reset signal, or a carry signal C(n), but is not limited thereto.

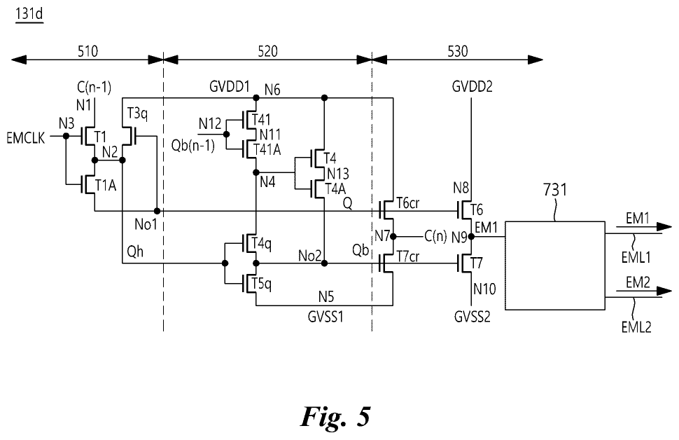

The waveform of the first light control signal EM1 may be different from that of the second light control signal EM2. Hereinafter, the structure of the second drive unit 131d will be described in detail. Referring to FIGS. 4 and 5, each of the second drive units 131d, 132d, and 133d may include a high power control unit 510, a low power control unit 520, and a signal output unit 530. For convenience of explanation, the second drive unit 131d will be described as an example.

FIG. 5 is a circuit diagram of the second drive unit 131d according to embodiments of the present disclosure.

Referring to FIG. 5, the second drive unit 131d may include a high power control unit 510, a low power control unit 520, and a signal output unit 530.

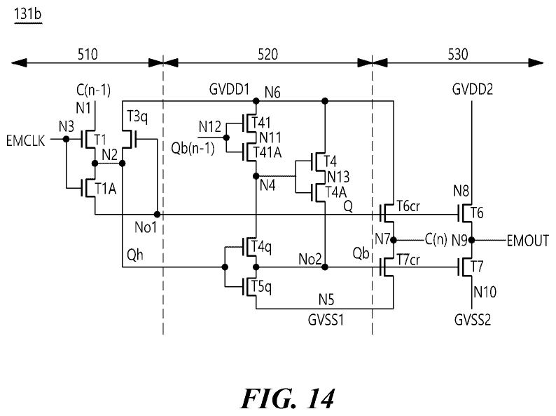

The features of the high power control unit 510 and the low power control unit 520 shown in FIG. 5 are the same as those of the high power control unit 510 and the low power control unit 520 shown in FIG. 14. Therefore, redundant descriptions thereof will be omitted. Detailed descriptions of the high power control unit 510 and the low power control unit 520 will be provided later, e.g., in the description of FIG. 14.

Referring to FIG. 5, the signal output unit 530 shown in FIG. 5 may include a first carry signal output transistor T6cr, a second carry signal output transistor T7cr, a first light-emitting signal output transistor T6, and a second light-emitting signal output transistor T7, and these elements are identical to the components of the signal output unit 530 shown in FIG. 14. However, referring to FIG. 5, an emission signal generation circuit 731 may be electrically connected to a ninth node N9. Referring to FIGS. 5 and 14, the first light control signal EM1 shown in FIG. 5 may be the same as the light-emitting signal EMOUT shown in FIG. 14.

The emission signal generation circuit 731 may receive the first light control signal EM1. The emission signal generation circuit 731 receives the first light control signal EM1 and may output the signal to a first light emission control signal line EML1.

The emission signal generation circuit 731 may receive the first light control signal EM1 and generate a second light control signal EM2 based on the received first light control signal EM1. The emission signal generation circuit 731 may output the second light control signal EM2 to a second light emission control signal line EML2.

The first light control signal EM1 in FIG. 5 is the same as the first light control signal EM1 shown in FIG. 3. The second light control signal EM2 in FIG. 5 is the same as the second light control signal EM2 shown in FIG. 3.

Hereinafter, the emission signal generation circuit 731 will be described with reference to an example.

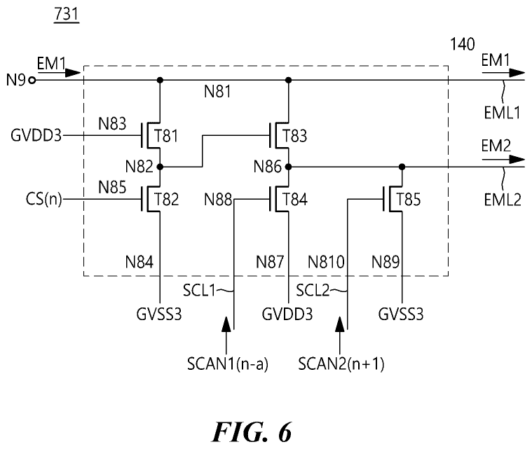

FIG. 6 is a diagram illustrating the emission signal generation circuit 731 according to embodiments of the present disclosure.

Referring to FIG. 6, the emission signal generation circuit 731 may include a first light-emitting signal transistor T81, a second light-emitting signal transistor T82, a third light-emitting signal transistor T83, a fourth light-emitting signal transistor T84, and a fifth light-emitting signal transistor T85. For convenience of explanation, all of the above-mentioned transistors T81 through T85 are assumed to be N-type transistors.

The first light-emitting signal transistor T81 may be electrically connected between a first node N81 and a second node N82. The gate node of the first light-emitting signal transistor T81 may be electrically connected to a third node N83. The third node N83 may be a node to which a third high voltage GVDD3 is supplied. Since the third high voltage GVDD3 is supplied to the gate node of the first light-emitting signal transistor T81, the first light-emitting signal transistor T81 may be continuously kept in a turned-on state.

The second light-emitting signal transistor T82 may be electrically connected between the second node N82 and a fourth node N84. The gate node of the second light-emitting signal transistor T82 may be electrically connected to a fifth node N85. The fifth node N85 may be a node to which a control signal CS(n) is supplied. The control signal CS(n) may control the state of the second light-emitting signal transistor T82 to be either turned-on or turned-off.

The third light-emitting signal transistor T83 may be electrically connected between the first node N81 and a sixth node N86. The gate node of the third light-emitting signal transistor T83 may be electrically connected to the second node N82.

The fourth light-emitting signal transistor T84 may be electrically connected between the sixth node N86 and a seventh node N87. The gate node of the fourth light-emitting signal transistor T84 may be electrically connected to an eighth node N88. The eighth node N88 may be electrically connected to a first scan signal line SCL1. The aforementioned first scan signal line SCL1 may supply an (n−a)-th first scan signal SCAN1_(n−a) to the eighth node N88. That is, the (n−a)-th first scan signal SCAN1_(n−a) may be supplied not only to subpixels SP arranged in the (n−a)-th row but also to the emission signal generation circuit 731 arranged in the n-th row. Here, a may be a natural number greater than or equal to 1. For example, assuming n is 10 and a is 5, the emission signal generation circuit 731 is arranged in the 10th row, and the first scan signal SCAN1 is generated by a gate driving circuit 130 arranged in the 5th row. The first scan signal SCAN1 may be a signal supplied to subpixels SP arranged in the 5th row.

The fifth light-emitting signal transistor T85 may be electrically connected between the sixth node N86 and the eighth node N88. The gate node of the fifth light-emitting signal transistor T85 may be electrically connected to a tenth node N810. The tenth node N810 may be electrically connected to a second scan signal line SCL2. The aforementioned second scan signal line SCL2 may supply an (n+1)-th second scan signal SCAN2_(n+1) to the tenth node N810. That is, the (n+1)-th second scan signal SCAN2_(n+1) may be supplied not only to subpixels SP arranged in the (n+1)-th row but also to the emission signal generation circuit 731 arranged in the n-th row. For example, assuming n is 10, the emission signal generation circuit 731 is arranged in the 10th row, and the second scan signal SCAN2 is generated by a gate driving circuit 130 arranged in the 11th row. The second scan signal SCAN2 may be a signal supplied to subpixels SP arranged in the 11th row.

The fourth node N84 and the ninth node N89 may be nodes to which a third low voltage GVSS3 is supplied. The seventh node N87 may be a node to which the third high voltage GVDD3 is supplied.

The channel widths of the first light-emitting signal transistor T81 and the third light-emitting signal transistor T83 may be narrower than those of the second light-emitting signal transistor T82, the fourth light-emitting signal transistor T84, and the fifth light-emitting signal transistor T85. Therefore, the amount of current flowing through the first light-emitting signal transistor T81 and the third light-emitting signal transistor T83 may be smaller than the current flowing through the second, fourth, and fifth light-emitting signal transistors T82, T84, and T85. For example, the channel widths of the second, fourth, and fifth light-emitting signal transistors T82, T84, and T85 may be 2 to 4 times larger than those of the first and third light-emitting signal transistors T81 and T83. The channel refers to the channel region between the source region and the drain region.

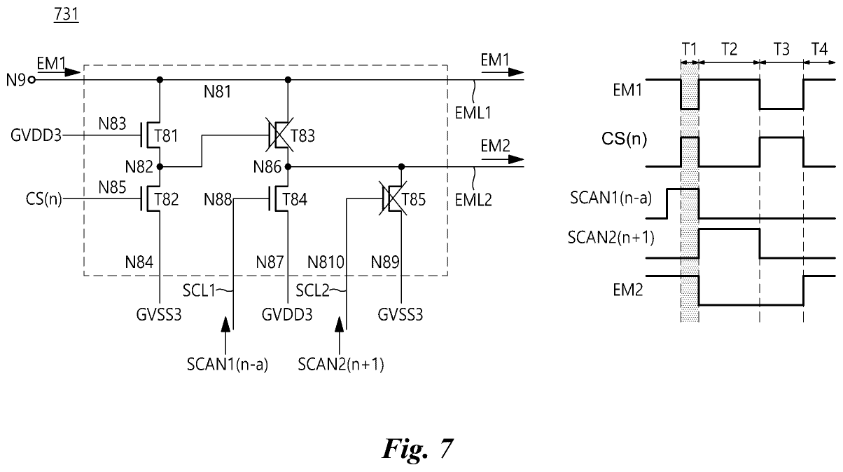

Referring to FIG. 6, the equivalent circuit of the emission signal generation circuit 731 has been described. Hereinafter, referring to FIGS. 7 through 11, the driving of the emission signal generation circuit 731 will be described.

FIGS. 7 to 12 are timing diagrams illustrating the driving timing of the emission signal generation circuit 731 according to embodiments of the present disclosure.

Referring to FIG. 7, the operation period of the emission signal generation circuit 731 may include a first period T1, a second period T2, a third period T3, and a fourth period T4.

The first period T1 may be a period during which the emission signal generation circuit 731 outputs the second light control signal EM2 at a high-level. The first light control signal EM1 is at a low level. During the first period T1, the first light-emitting signal transistor T81, the second light-emitting signal transistor T82, and the fourth light-emitting signal transistor T84 may be in a turned-on state.

During the first period T1, the gate node of the first light-emitting signal transistor T81 may be supplied with the third high voltage GVDD3, the gate node of the second light-emitting signal transistor T82 may be supplied with a high-level signal of the control signal CS(n), and the fourth light-emitting signal transistor T84 may be supplied with the high-level (n−a)-th first scan signal SCAN1(n−a).

During the first period T1, the fourth node N84 may be supplied with the third low voltage GVSS3. Because the second light-emitting signal transistor T82 is turned on, the second node N82 may be electrically connected to the fourth node N84. Therefore, the second node N82 may be supplied with the third low voltage GVSS3. Accordingly, the gate node of the third light-emitting signal transistor T83 may be supplied with the third low voltage GVSS3, and the third light-emitting signal transistor T83 may be in a turned-off state.

It should be appreciated that the description herein uses NMOS as an example to illustrate the operations of the transistors of the emission signal generation circuit 731. The emission signal generation circuit 731 may also be implemented using PMOS transistors, which are turned on based on logic low gate voltage and are turned off based on logic high gate voltage. Other type of transistors may also be used, which are all included in the scope of the disclosure.

During the first period T1, the gate node of the fifth light-emitting signal transistor T85 may be supplied with the low-level (n+1)-th second scan signal SCAN2(n+1), so the fifth light-emitting signal transistor T85 may be in a turned-off state.

During the first period T1, the gate node of the fourth light-emitting signal transistor T84 may be supplied with the high-level (n−a)-th first scan signal SCAN1(n−a). Therefore, the fourth light-emitting signal transistor T84 may be in a turned-on state, and the seventh node N87 may be electrically connected to the sixth node N86. The sixth node N86 may be electrically connected to the second light control signal line EML2, and the third high voltage GVDD3 supplied to the sixth node N86 may be supplied to the second light control signal line EML2. Accordingly, the second light control signal EM2 may be at the third high voltage level of GVDD3.

The second period T2 may be a period during which the emission signal generation circuit 731 outputs the second light control signal EM2 as a low-level signal.

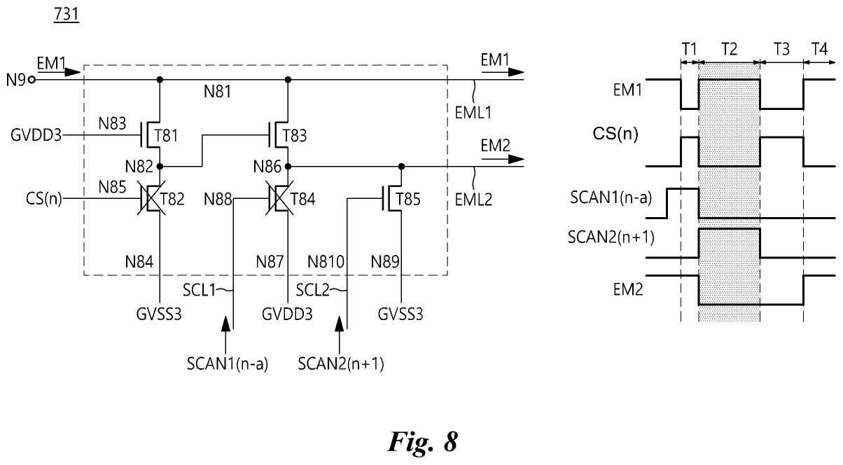

Referring to FIG. 8, during the second period T2, the first light-emitting signal transistor T81, the third light-emitting signal transistor T83, and the fifth light-emitting signal transistor T85 may be turned on.

During the second period T2, the second light-emitting signal transistor T82 may be controlled to be turned off, so the first light control signal EM1, which is at a high-level, may be supplied to the second node N82. The first light control signal EM1 may be supplied to the gate node of the third light-emitting signal transistor T83, and the third light-emitting signal transistor T83 may be turned on.

During the third period T3, the fifth light-emitting signal transistor T85 may be turned on, and thus the ninth node N89 may be electrically connected to the sixth node N86.

Because the third light-emitting signal transistor T83 is turned on, the first light control signal EM1, a high-level signal, may be supplied to the sixth node N86. Also, since the fifth light-emitting signal transistor T85 is turned on, the third low voltage GVSS3 may be supplied to the sixth node N86. Although both the high-level voltage and the third low voltage GVSS3 are supplied simultaneously to the sixth node N86, the voltage of the sixth node N86 may be at the third low voltage GVSS3 or a voltage level similar to GVSS3. The channel width of the fifth light-emitting signal transistor T85 is wider than that of the third light-emitting signal transistor T83, so the transmission of the third low voltage GVSS3 by the fifth light-emitting signal transistor T85 may be greater than the transmission of the high-level signal by the third transistor T83. Therefore, the voltage at the sixth node N86 may be at the third low voltage GVSS3 or a similar voltage level. The aforementioned channel refers to the channel region between the source and drain regions.

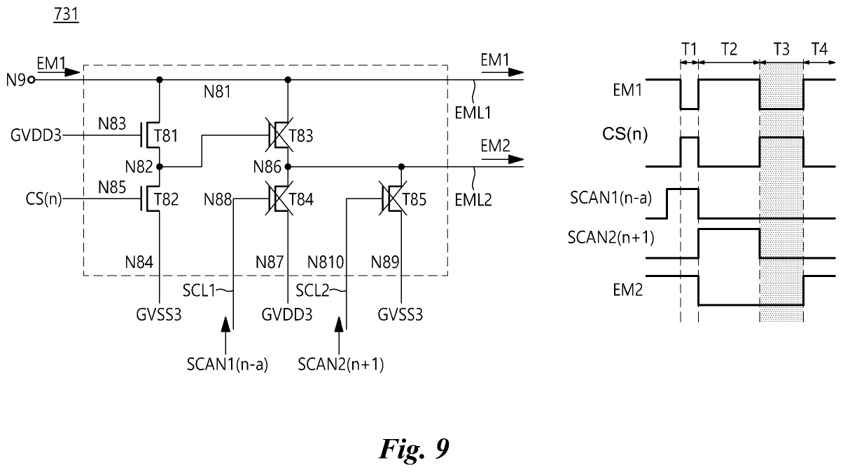

Referring to FIG. 9, the third period T3 may be a period, during which the emission signal generation circuit 731 outputs the second light control signal EM2 as a low-level signal.

During the third period T3, the third light-emitting signal transistor T83, the fourth light-emitting signal transistor T84, and the fifth light-emitting signal transistor T85 may be turned off.

During the third period T3, the first light-emitting signal transistor T81 and the second light-emitting signal transistor T82 may be turned on. Since the first and second light-emitting signal transistors T81 and T82 are turned on, the second node N82 may be supplied with the low-level first light control signal EM1 and the third low voltage GVSS3. Because the second node N82 is supplied with the low-level signal and the third low voltage GVSS3, the third light-emitting signal transistor T83 may be turned off.

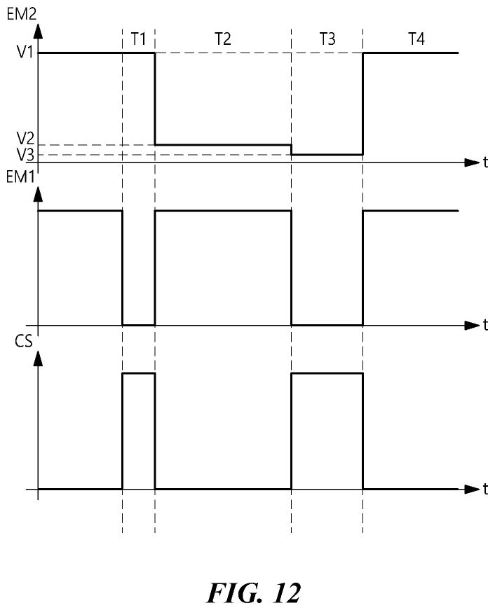

During the third period T3, since the third and fifth light-emitting signal transistors T83 and T85 remain turned off, the sixth node N86 may be in a floating state without any supplied voltage. When the sixth node N86 is floating, its voltage may somewhat decrease. Therefore, the voltage level of the second light control signal EM2 during the third period T3 may be slightly lower than that during the second period T2. Referring to FIG. 12, the voltage level of the second light control signal EM2 is at a second voltage level V2 during the second period T2, whereas it is at a third voltage level V3 during the third period T3. The second voltage level V2 may be higher than the third voltage level V3.

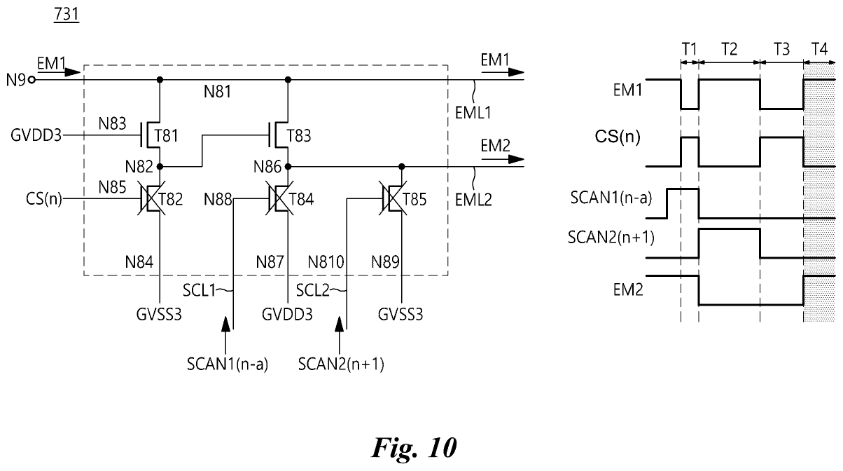

Referring to FIG. 10, the fourth period T4 may be a period during which the emission signal generation circuit 731 outputs the second light control signal EM2 as a high-level signal.

During the fourth period T4, the first light-emitting signal transistor T81 and the third light-emitting signal transistor T83 may be in a turned-on state.

During the fourth period T4, the second light-emitting signal transistor T82, the fourth light-emitting signal transistor T84, and the fifth light-emitting signal transistor T85 may be in a turned-off state.

During the fourth period T4, the first light-emitting signal transistor T81 may be in the turned-on state, and the first light control signal EM1, which is at a high-level, may be supplied to the second node N82. Therefore, the third light-emitting signal transistor T83 may be in the turned-on state.

During the fourth period T4, the third light-emitting signal transistor T83 may be in the turned-on state, and at this time, the first light control signal EM1 is at a high-level. The high-level first light control signal EM1 may be supplied to the sixth node N86. Therefore, the second light control signal EM2 may be in a high-level state.

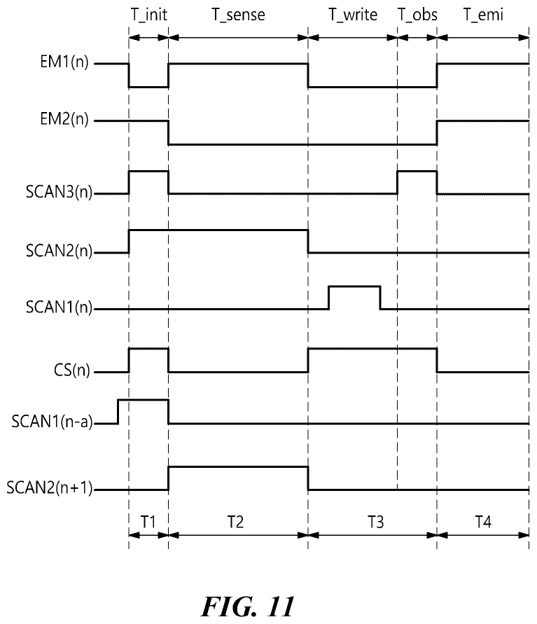

Referring to FIG. 11, the driving timing for driving the subpixels SP located in the n-th row and the driving timing for the emission signal generation circuit 731 located in the n-th row are also illustrated together.

The characteristics of the initialization period T_init, sensing period T_sense, data writing period T_write, bias period T_obs, and emission period T_emi shown in FIG. 11 are the same as those of the initialization period T_init, sensing period T_sense, data writing period T_write, bias period T_obs, and emission period T_emi shown in FIG. 3, so repetitive explanation is omitted.

The first period T1 to the fourth period T4 shown in FIG. 11 are the same as the first period T1 to the fourth period T4 shown in FIGS. 7 to 10. That is, the characteristics of the first light control signal EM1, the second light control signal EM2, the (n−a)-th first scan signal SCAN1(n−a), and the (n+1)-th second scan signal SCAN2(n+1) shown in FIG. 11 are the same as those described in FIGS. 7 to 10.

Referring to FIG. 12, the voltage states of the first light control signal EM1, the second light control signal EM2, and the control signals over time can be confirmed. The control signal CS shown in FIG. 12 may be the same as the control signal CS n shown in FIGS. 7 to 10.

The first light control signal EM1 shown in FIG. 12 may be the same as the first light control signal EM1 shown in FIGS. 7 to 11.

The second light control signal EM2 shown in FIG. 12 may be the same as the second light control signal EM2 shown in FIGS. 9 to 11.

Referring to FIG. 12, the second light control signal EM2 may be at a first voltage level V1 during the first period T1. The first voltage level V1 may be the same as the third high voltage GVDD3 shown in FIG. 7.

Referring to FIG. 12, the second light control signal EM2 may be at a second voltage level V2 during the second period T2. The second voltage level V2 may be lower than the first voltage level V1.

Referring to FIG. 12, the second light control signal EM2 may be at a third voltage level V3 during the third period T3. The third voltage level V3 may be lower than the second voltage level V2.

The features of the present disclosure described above can be briefly summarized as follows. The gate driving circuit 130 according to the embodiment of the present disclosure may include a first drive unit 131a and a second drive unit 131d (FIG. 5). The first drive unit 131a may generate the first light control signal EM1, and the second drive unit 131d may generate the second light control signal EM2. The second drive unit 131d may include an emission signal generation circuit 731. The emission signal generation circuit 731 may generate both the first light control signal EM1 and the second light control signal EM2 based on the first light control signal EM1. The emission signal generation circuit 731 may receive a high voltage, a low voltage, the first scan signal SCAN1, the second scan signal SCAN2, and a control signal. The first light control signal EM1 and the second light control signal EM2 may have different signal waveforms. The first light control signal EM1 and the second light control signal EM2 may be supplied to subpixels SP for internal compensation.

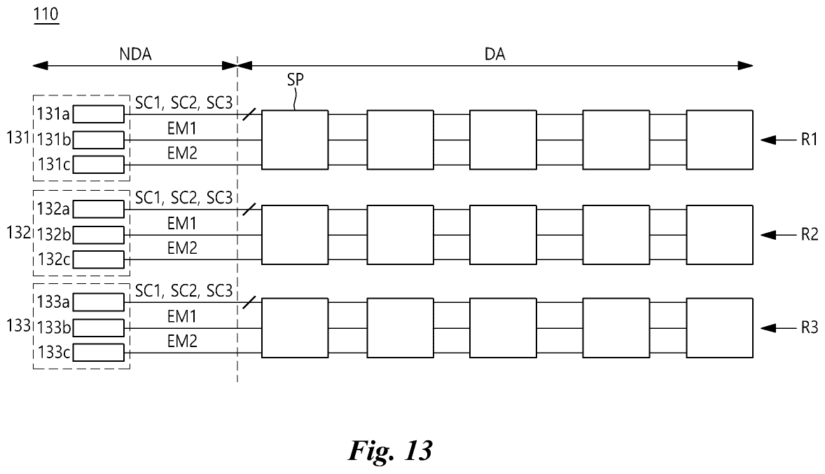

FIG. 13 is a diagram relating to the gate driving circuit 130 and subpixel SP according to embodiments of the present disclosure.

Referring to FIG. 13, a plurality of subpixels SP may be arranged in a display area DA. The gate driving circuit 130 may be arranged in a non-display area NDA. The gate driving circuit 130 may supply signals to the plurality of subpixels SP arranged in the display area DA. The gate driving circuit 130 may supply the first light control signal EM1n, the second light control signal EM2n, the first scan signal SCAN1n, the second scan signal SCAN2n, and the third scan signal SCAN3n to the subpixels SP.

The gate driving circuit 130 may include a plurality of stage circuits 131, 132, and 133. For example, the stage circuit arranged in the first row R1 may be the first stage circuit 131. The stage circuit arranged in the second row R2 may be the second stage circuit 132. The stage circuit arranged in the third row R3 may be the third stage circuit 133.

The first stage circuit 131 may supply signals to the subpixels SP arranged in the first row R1. The second stage circuit 132 may supply signals to the subpixels SP arranged in the second row R2. The third stage circuit 133 may supply signals to the subpixels SP arranged in the third row R3.

Each of the plurality of stage circuits 131, 132, and 133 may include a first drive unit 131a, 132a, 133a, a second drive unit 131b, 132b, 133b, and a third drive unit 131c, 132c, 133c. Hereinafter, for convenience of explanation, the description will be based on the first drive unit 131a, the second drive unit 131b, and the third drive unit 131c arranged in the first row.

The first drive unit 131a may be a circuit configured to output the first scan signal SCAN1, the second scan signal SCAN2, and the third scan signal SCAN3. The second drive unit 131b may be a circuit configured to output the first light control signal EM1. The third drive unit 131c may be a circuit configured to output the second light control signal EM2.

The second drive units 131b arranged in multiple rows may be electrically connected to each other. For example, the second drive unit 131b arranged in the second row R2 may be electrically connected to the second drive unit 131b of the first row R1 and the second drive unit 131b of the third row R3. That is, the second drive unit 131b of the n-th row may be electrically connected to the second drive unit 131b of the (n+1)-th row and the second drive unit 131b of the (n−1)-th row, where n is a natural number equal to or greater than 2. The above-described features of the second drive unit 131b are included in the features of the third drive unit 131c and the first drive unit 131a.

Since the second drive units 131b arranged in multiple rows can exchange signals with each other, they may be sequentially driven. For example, after the second drive unit 131b arranged in the first row R1 outputs a signal, it may supply a specific signal to the second drive unit 131b arranged in the second row R2. After the second drive unit 131b arranged in the second row R2 outputs a signal, it may supply a specific signal to the second drive unit 131b arranged in the third row R3. For example, the aforementioned specific signals may be a setting signal, a reset signal, a carry signal, or the like, but are not limited thereto. The above-described features of the second drive unit 131b are included in the features of the third drive unit 131c and the first drive unit 131a.

The second drive unit 131b may output the first light control signal EM1, and the third drive unit 131c may output the second light control signal EM2. The first light control signal EM1 may have a different signal waveform from the second light control signal EM2. However, although the signal waveforms differ, the circuit configuration for outputting the signals may be the same. Hereinafter, the structure of the second drive unit 131b and the third drive unit 131c will be described.

FIG. 14 is a circuit diagram related to the second drive unit 131b according to embodiments of the present disclosure.

Referring to FIG. 14, an example of a specific circuit of the second drive unit 131b shown in FIG. 13 can be confirmed. The characteristics of the second drive unit 131b may be identical to those of the third drive unit 131c. For convenience of explanation, the description will focus on the second drive unit 131b, and these characteristics may also apply to the third drive unit 131c.

Referring to FIG. 14, the second drive unit 131b may include a high power control unit 510, a low power control unit 520, and a signal output unit 530. The high power control unit 510 and the low power control unit 520 may be defined as logic units. The signal output unit 530 may be defined as a buffer or output buffer unit. The high power control unit 510 and the low power control unit 520 can control the voltages of the Q node Q and the QB node Qb. The Q node Q may be defined as the first output control node No1, and the QB node Qb may be defined as the second output control node No2.

The high power control unit 510 can control the signal output unit 530 to output a high-level signal. When the high power control unit 510 controls the signal output unit 530, the low power control unit 520 may not control the signal output unit 530.

The low power control unit 520 can control the signal output unit 530 to output a low-level signal. When the low power control unit 520 controls the signal output unit 530, the high power control unit 510 may not control the signal output unit 530.

The signal output unit 530 can output a carry signal C(n) and a light emission signal EMOUT. When controlled by the high power control unit 510, the signal output unit 530 may output the carry signal C(n) and the light emission signal EMOUT as high-level signals. When controlled by the low power control unit 520, the signal output unit 530 may output the carry signal C(n) and the light emission signal EMOUT as low-level signals.

The high power control unit 510 may include a first carry signal transistor T1, a second carry signal transistor T1A, and a third carry signal transistor T3q.

The low power control unit 520 may include a first high power control transistor T4q, a second high power control transistor T5q, a first low power control transistor T41, a second low power control transistor T41A, a third low power control transistor T4, and a fourth low power control transistor T4A.

The signal output unit 530 may include a first carry signal output transistor T6cr, a second carry signal output transistor T7cr, a first light-emitting signal output transistor T6, and a second light-emitting signal output transistor T7.

For convenience of explanation, all the transistors mentioned above are assumed to be N-type transistors. The second drive unit 131b may be supplied with a first high voltage GVDD1 and a second high voltage GVDD2. The first high voltage GVDD1 and the second high voltage GVDD2 may be voltages of the same magnitude, but considering the characteristics of the transistors, they may also be voltages of different magnitudes. The same applies if a third high voltage GVDD3 is additionally supplied. The second drive unit 131b may also be supplied with a first low voltage GVSS1 and a second low voltage GVSS2. The first low voltage GVSS1 and the second low voltage GVSS2 may be voltages of the same magnitude or different magnitudes. The same applies if a third low voltage GVSS3 is additionally supplied.

The high power control unit 510 can set the first output control node No1 to a high-level signal state so that the signal output unit 530 can output high-voltage signals. This will be explained first. Then, the low power control unit 520 sets the second output control node No2 to a high-level signal state so that the signal output unit 530 outputs low-voltage signals, which will be explained thereafter.

The following content is an example of a method in which the high power control unit 510 sets the first output control node No1 to a high-level signal state so that the signal output unit 530 outputs high-voltage signals.

This describes a method in which, after the first carry signal transistor T1 turns on, the second output control node No2 is stably maintained at a low-level signal.

The first carry signal transistor T1 may be electrically connected between a first node N1 and a second node N2. The gate node of the first carry signal transistor T1 may be electrically connected to a third node N3. The first node N1 may be a node where the (n−1)th carry signal C(n−1) is supplied. The nth carry signal C(n) refers to the carry signal C(n) associated with the gate driving circuit 130 arranged in the nth row, and the (n−1)th carry signal C(n−1) refers to the carry signal C(n) associated with the gate driving circuit 130 arranged in the (n−1)th row. Here, n is a natural number equal to or greater than 2. The third node N3 may be a node to which the emission clock signal EMCLK is supplied. The emission clock signal EMCLK may be a signal where high-level and low-level signals alternately repeat at a fixed cycle. When the first carry signal transistor T1 is turned on, the (n−1)th carry signal C(n−1) may be supplied to the second node N2.

The first high power control transistor T4q may be electrically connected between a fourth node N4 and the second output control node No2. The gate node of the first high power control transistor T4q may be electrically connected to the second node N2. The second high power control transistor T5q may be electrically connected between the second output control node No2 and a fifth node N5. The gate node of the second high power control transistor T5q may be electrically connected to the second node N2.

When the first carry signal transistor T1 is turned on, the (n−1)th carry signal C(n−1) may be supplied to the second node N2. At this time, the first high power control transistor T4q and the second high power control transistor T5q may be controlled by the (n−1)th carry signal C(n−1) to be turned on. The fifth node N5 may be a node to which the first low voltage GVSS1 is supplied. Since the first high power control transistor T4q and the second high power control transistor T5q are turned on, the voltage of the fifth node N5 may be supplied to the fourth node N4. The fourth node N4 may be electrically connected to the gate nodes of the third low power control transistor T4 and the second low power control transistor T41A. The voltage level of the fourth node N4 may be the first low voltage GVSS1, and the third low power control transistor T4 and the second low power control transistor T41A, which receive the first low voltage GVSS1 at their gate nodes, may be maintained in an off state. Accordingly, the second output control node No2 may be stably maintained at a low-level signal.

After the first carry signal transistor T1 is turned on, the method by which the second output control node No2 is stably maintained at a low-level signal has been explained. Next, the method by which, after the second carry signal transistor T1A is turned on, the first output control node No1 is maintained at a high-level signal and the signal output unit 530 outputs signals will be explained.

The second carry signal transistor T1A may be electrically connected between the second node N2 and the first output control node No1. The gate node of the second carry signal transistor T1A may be electrically connected to the third node N3. When the second carry signal transistor T1A is turned on, the first carry signal transistor T1 may also be turned on. Therefore, when the second carry signal transistor T1A is turned on, the (n−1)th carry signal C(n−1) may be supplied to the first output control node No1. The (n−1)th carry signal C(n−1) may be in a high-level signal state, and the first output control node No1 may be in a high-level signal state as it receives the (n−1)th carry signal C(n−1).

The first carry signal output transistor T6cr may be electrically connected between the sixth node N6 and the seventh node N7. The gate node of the first carry signal output transistor T6cr may be electrically connected to the first output control node No1. As the voltage level of the first output control node No1 becomes a high-level signal, the first carry signal output transistor T6cr may be turned on. The sixth node N6 may be a node supplied with the first high voltage GVDD1. When the first carry signal output transistor T6cr is turned on, the first high voltage GVDD1 may be supplied to the seventh node N7. Accordingly, the voltage state of the nth carry signal C(n) may be the first high voltage GVDD1, and the signal output unit 530 may output the nth carry signal C(n) in the first high voltage GVDD1 state.

The first light-emitting signal output transistor T6 may be electrically connected between the eighth node N8 and the ninth node N9. The gate node of the first light-emitting signal output transistor T6 may be electrically connected to the first output control node No1. As the voltage level of the first output control node No1 becomes a high-level signal, the first light-emitting signal output transistor T6 may be turned on. The eighth node N8 may be a node supplied with the second high voltage GVDD2. When the first light-emitting signal output transistor T6 is turned on, the second high voltage GVDD2 may be supplied to the ninth node N9. Accordingly, the voltage state of the light-emitting signal EMOUT may be the first high voltage GVDD1, and the signal output unit 530 may output the light-emitting signal EMOUT in the first high voltage GVDD1 state. The light-emitting signal EMOUT may be a first light control signal EM1n for the nth row.

After the second carry signal transistor T1A is turned on, the method in which the first output control node No1 is maintained in a high-level signal state and the signal output unit 530 outputs a high voltage state signal has been described. Next, the method in which the low power control unit 520 makes the second output control node No2 a high-level signal and then the signal output unit 530 outputs a low voltage state signal will be described.

The voltage level of the (n−1)th carry signal C(n−1) may change from a high-level signal to a low-level signal. Accordingly, the voltage of the first output control node No1 may be maintained as a low-level signal. At this time, the first carry signal output transistor T6cr and the first light-emitting signal output transistor T6 may be turned off. When the voltage level of the (n−1)th carry signal C(n−1) changes from a high-level signal to a low-level signal, the voltage Qb_(n−1) of the (n−1)th second output control node No2 may change from a low-level signal to a high-level signal.

When the voltage Qb_(n−1) of the (n−1)th second output control node No2 changes from a low-level signal to a high-level signal, the first low power control transistor T41 and the second low power control transistor T41A may be turned on.

The first low power control transistor T41 may be electrically connected between the sixth node N6 and the eleventh node N11. The second low power control transistor T41A may be electrically connected between the eleventh node N11 and the fourth node N4. The gate nodes of the first low power control transistor T41 and the second low power control transistor T41A may be electrically connected to the twelfth node N12. The twelfth node N12 may be a node where the voltage Qb_(n−1) of the (n−1)th second output control node No2 is supplied. When the first low power control transistor T41 and the second low power control transistor T41A are turned on, the sixth node N6 may be electrically connected to the fourth node N4.

The fourth node N4 may be electrically connected to the gate nodes of the third low power control transistor T4 and the second low power control transistor T41A. The third low power control transistor T4 may be electrically connected between the sixth node N6 and the thirteenth node N13. The second low power control transistor T41A may be electrically connected between the thirteenth node N13 and the second output control node No2. When the first high voltage GVDD1 is supplied to the fourth node N4, the third low power control transistor T4 and the second low power control transistor T41A may be turned on. Accordingly, the sixth node N6 and the second output control node No2 may be electrically connected. The first high voltage GVDD1 of the sixth node N6 may be supplied to the second output control node No2, and accordingly, the voltage state of the second output control node No2 may be the first high voltage GVDD1.

The second output control node No2 may be electrically connected to the gate nodes of the second carry signal output transistor T7cr and the second light-emitting signal output transistor T7. When the second output control node No2 receives the first high voltage GVDD1, the second carry signal output transistor T7cr and the second light-emitting signal output transistor T7 may be turned on.

The second carry signal output transistor T7cr may be electrically connected between the seventh node N7 and the fifth node N5. The fifth node N5 may be a node supplied with the first low voltage GVSS1. When the second carry signal output transistor T7cr is turned on, the seventh node N7 may be electrically connected to the fifth node N5. Accordingly, the first low voltage GVSS1 may be supplied to the seventh node N7. Therefore, the voltage state of the nth carry signal C(n) may be the first low voltage GVSS1. In other words, the signal output unit 530 may output the nth carry signal C(n) in the first low voltage GVSS1 state.

The second light-emitting signal output transistor T7 may be electrically connected between the ninth node N9 and the tenth node N10. The tenth node N10 may be a node supplied with the second low voltage GVSS2. When the second light-emitting signal output transistor T7 is turned on, the ninth node N9 may be electrically connected to the tenth node N10. Accordingly, the second low voltage GVSS2 may be supplied to the ninth node N9. Therefore, the voltage state of the light-emitting signal EMOUT may be the second low voltage GVSS2. In other words, the signal output unit 530 may output the light-emitting signal EMOUT in the second low voltage GVSS2 state.

The low power control unit 520 may set the second output control node No2 to a high-level signal, and thereafter the signal output unit 530 may output a signal at a low voltage state. The configurations including the aforementioned high power control unit 510, low power control unit 520, and signal output unit 530 are only examples, and the embodiments of the present disclosure are not limited thereto. To perform the same functions as the aforementioned high power control unit 510, low power control unit 520, and signal output unit 530, other transistors may be added, some transistors illustrated in FIG. 14 may be omitted, and separate capacitors may also be additionally included.

The high power control unit 510, low power control unit 520, and signal output unit 530 included in the second drive unit 131b have been described. The third drive unit 131c may also include the high power control unit 510, low power control unit 520, and signal output unit 530, and the characteristics of the third drive unit 131c may be the same as those of the second drive unit 131b.

Referring to FIG. 13, the second drive unit 131b outputs the first light control signal EM1, and the third drive unit 131c outputs the second light control signal EM2. If a circuit capable of integrating the functions of the second drive unit 131b and the third drive unit 131c can be implemented, the area occupied by the gate driving circuit 130 may be reduced. Accordingly, the size of the bezel may be reduced. Thus, the embodiments of the present disclosure may provide a display device capable of reducing the bezel size through a new gate driving circuit 130.

The embodiments of the present disclosure may provide a display device capable of simultaneously generating the first light control signal EM1 and the second light control signal EM2 through a new gate driving circuit 130.

The embodiments of the present disclosure may provide a display device capable of low-power driving through a new gate driving circuit 130.

The display device according to the embodiments of the present disclosure may be described as follows.

In one or more aspects, The embodiments of the present disclosure include a first subpixel located in a display area and including a light emitting element, a first light emission control signal line electrically connected to the first subpixel and supplying a first light control signal controlling the emission timing of the light emitting element, a second light emission control signal line electrically connected to the first subpixel and supplying a second light control signal controlling the emission timing of the light emitting element, and a gate driving circuit that supplies the first light control signal to the first light emission control signal line and supplies the second light control signal to the second light emission control signal line. The gate driving circuit includes Q and QB nodes, a logic part controlling the voltage states of the Q and QB nodes, and a signal output unit that outputs a signal whose voltage level varies according to the voltage states of the Q and QB nodes. The signal output unit includes a first light-emitting signal output transistor controlled by the voltage state of the Q node, a second light-emitting signal output transistor controlled by the voltage state of the QB node and electrically connected to the first light-emitting signal output transistor at a connection node, and an emission signal generation circuit electrically connected at the connection node to the first and second light-emitting signal output transistors, which receives an input voltage and outputs the first light control signal to the first light emission control signal line and the second light control signal to the second light emission control signal line based on the input voltage.

In one or more aspects, The emission signal generation circuit may include a first light-emitting signal transistor electrically connected between a first node and a second node and controlled by the voltage state of a third node, a second light-emitting signal transistor electrically connected between the second node and a fourth node and controlled by the voltage state of a fifth node, a third light-emitting signal transistor electrically connected between the first node and a sixth node and controlled by the voltage state of the second node, a fourth light-emitting signal transistor electrically connected between the sixth node and a seventh node and controlled by the voltage state of an eighth node, and a fifth light-emitting signal transistor electrically connected between the sixth node and a ninth node and controlled by the voltage state of a tenth node.

In one or more aspects, The first node may be electrically connected to the connection node and the first light emission control signal line, and the sixth node may be electrically connected to the second light emission control signal line.

In one or more aspects, The input voltage may be the first light control signal.

In one or more aspects, During a first period, the fourth light-emitting signal transistor is in a turned-on state, the seventh node receives a high-level signal, and during the first period, the emission signal generation circuit may output the second light control signal, which is the high-level signal, to the second light emission control signal line.

In one or more aspects, During the first period, the first light-emitting signal transistor is in a turned-on state, the first light control signal is a low-level signal, and during the first period, the low-level signal is supplied to the gate node of the third light-emitting signal transistor, so that the third light-emitting signal transistor may be in a turned-off state.

In one or more aspects, During the first period, the second light-emitting signal transistor is in a turned-on state, the low-level signal is supplied to the fourth node, and during the first period, the second node receives the low-level signal. The low-level signal supplied to the gate node of the third light-emitting signal transistor may cause the third light-emitting signal transistor to be in a turned-off state.

In one or more aspects, During a second period after the first period, the third and fifth light-emitting signal transistors are in a turned-on state, the low-level signal is supplied to the ninth node, and during the second period, the second light emission control signal line receives either the low-level signal or a first voltage higher than the low-level signal. The emission signal generation circuit may supply the second light control signal, which is either the low-level signal or the first voltage, to the second light emission control signal line.

In one or more aspects, During the second period, the sixth node simultaneously receives the low-level signal supplied to the ninth node and the high-level signal of the first light control signal supplied to the first node. When the sixth node simultaneously receives the low-level signal supplied to the ninth node and the high-level signal of the first light control signal supplied to the first node, the voltage level of the sixth node may be the same as the low-level signal or the first voltage.

In one or more aspects, The fifth and third light-emitting signal transistors include source regions, drain regions, and channel regions between the source and drain regions, and the channel region width of the fifth light-emitting signal transistor may be larger than that of the third light-emitting signal transistor.

In one or more aspects, During a third period after the second period, the third, fourth, and fifth light-emitting signal transistors are in a turned-off state, and the emission signal generation circuit may output the second light control signal, which is the low-level signal or a second voltage higher than the low-level signal, to the second light emission control signal line.

In one or more aspects, During the third period, the third light-emitting signal transistor, the fourth light-emitting signal transistor, and the fifth light-emitting signal transistor are in a turned-off state, and the sixth node may be electrically floating.

In one or more aspects, The first voltage, which is the voltage level of the second light control signal during the second period, may be greater than the second voltage, which is the voltage level of the second light control signal during the third period.

In one or more aspects, During the third period, the first light control signal may be a low-level signal.

In one or more aspects, During the fourth period after the third period, the third light-emitting signal transistor is in a turned-on state, the fourth and fifth light-emitting signal transistors are in a turned-off state, and during the fourth period, the emission signal generation circuit may output the high-level second light control signal to the second light emission control signal line.

In one or more aspects, During the fourth period, the first light control signal is the high-level signal, and during the fourth period, the high-level first light control signal may be supplied to the sixth node electrically connected to the second light emission control signal line.

In one or more aspects, The gate node of the first light-emitting signal transistor receives a high voltage maintained at a constant voltage level, the gate node of the second light-emitting signal transistor receives a first control signal whose voltage level varies over time, the gate node of the fourth light-emitting signal transistor receives a second control signal whose voltage level varies over time, and the gate node of the fifth light-emitting signal transistor may receive a third control signal whose voltage level varies over time.

In one or more aspects, It further includes multiple subpixels arranged in a matrix form of multiple rows and multiple columns, wherein the first subpixel is located in the nth row, the second subpixel is located in the (n+1)th row following the nth row, and the third subpixel is located in the ((n−a))th row preceding the nth row, where n is a natural number and a is a natural number smaller than n.

In one or more aspects, The second control signal is a first scan signal for the ((n−a))th row supplied to the third subpixel, and the third control signal may be a second scan signal for the (n+1)th row supplied to the second subpixel.

In one or more aspects, The first subpixel is electrically connected between the first pixel node and the second pixel node, includes a first transistor whose gate pixel node is electrically connected to a third pixel node, a second transistor electrically connected between the second pixel node and the driving voltage line, whose gate pixel node is electrically connected to the first light emission control signal line, a third transistor electrically connected between the third pixel node and the data line, whose gate pixel node is electrically connected to a first scan signal line supplying a first scan signal for the nth row, a fourth transistor electrically connected between the first pixel node and the fourth pixel node, whose gate pixel node is electrically connected to the second light emission control signal line, a fifth transistor electrically connected between the third pixel node and the reference voltage line, whose gate pixel node is electrically connected to a second scan signal line supplying a second scan signal for the nth row, a sixth transistor electrically connected between the fourth pixel node and the reset voltage line, whose gate pixel node is electrically connected to a third scan signal line, a seventh transistor electrically connected between the first pixel node and the initialization voltage line, whose gate pixel node is electrically connected to the third scan signal line, a first capacitor electrically connected between the first pixel node and the third pixel node, a second capacitor electrically connected between the first pixel node and the DC voltage line, and a light emitting element electrically connected between the fourth pixel node and the base voltage line.

The above description has been presented to enable any person skilled in the art to make and use the technical idea of the present disclosure, and has been provided in the context of a particular application and its requirements. Various modifications, additions and substitutions to the described embodiments will be readily apparent to those skilled in the art, and the general principles defined herein may be applied to other embodiments and applications without departing from the spirit and scope of the present disclosure. The above description and the accompanying drawings provide an example of the technical idea of the present disclosure for illustrative purposes only. That is, the disclosed embodiments are intended to illustrate the scope of the technical idea of the present disclosure.

The various embodiments described above can be combined to provide further embodiments. Aspects of the embodiments can be modified, if necessary to employ concepts of the various embodiments to provide yet further embodiments.

These and other changes can be made to the embodiments in light of the above-detailed description. In general, in the following claims, the terms used should not be construed to limit the claims to the specific embodiments disclosed in the specification and the claims, but should be construed to include all possible embodiments along with the full scope of equivalents to which such claims are entitled. Accordingly, the claims are not limited by the disclosure.

1. A display device comprising:
a first subpixel located in a display area and including a light emitting element;
a first light emission control signal line electrically connected to the first subpixel and configured to supply a first light control signal for controlling a light emission timing of the light emitting element;
a second light emission control signal line electrically connected to the first subpixel and configured to supply a second light control signal for controlling the light emission timing of the light emitting element; and
a gate driving circuit configured to supply the first light control signal to the first light emission control signal line and to supply the second light control signal to the second light emission control signal line,
wherein the gate driving circuit comprises:
a logic unit including a Q node and a QB node and configured to control voltage states of the Q node and the QB node; and
a signal output unit configured to output a signal having a voltage level that varies based on the voltage states of the Q node and the QB node,
wherein the signal output unit comprises:
a first light-emitting signal output transistor controlled by the voltage state of the Q node;
a second light-emitting signal output transistor controlled by the voltage state of the QB node and electrically connected to the first light-emitting signal output transistor at a connection node; and
an emission signal generation circuit electrically connected to the first and second light-emitting signal output transistors at the connection node, configured to receive a voltage of the connection node as an input voltage, output the first light control signal to the first light emission control signal line based on the input voltage, and output the second light control signal to the second light emission control signal line based on the input voltage.

2. The display device of claim 1, wherein the emission signal generation circuit includes:
a first light-emitting signal transistor electrically connected between a first node and a second node, and configured to be controlled by a voltage level of a third node;
a second light-emitting signal transistor electrically connected between the second node and a fourth node, and configured to be controlled by a voltage level of a fifth node;
a third light-emitting signal transistor electrically connected between the first node and a sixth node, and configured to be controlled by a voltage level of the second node;
a fourth light-emitting signal transistor electrically connected between the sixth node and a seventh node, and configured to be controlled by a voltage level of an eighth node; and
a fifth light-emitting signal transistor electrically connected between the sixth node and a ninth node, and configured to be controlled by a voltage level of a tenth node.

3. The display device of claim 2, wherein the first node is electrically connected to the connection node and the first light emission control signal line, and
the sixth node is electrically connected to the second light emission control signal line.

4. The display device of claim 3, wherein the input voltage is the first light control signal.

5. The display device of claim 3, wherein, during a first period, the fourth light-emitting signal transistor is in a turn-on state, and a high-level signal is supplied to the seventh node, and
during the first period, the emission signal generation circuit is configured to output the second light control signal at a high-level, to the second light emission control signal line.

6. The display device of claim 5, wherein, during the first period, the first light-emitting signal transistor is in a turn-on state, the first light control signal is at a low-level, and
during the first period a low-level signal is supplied to a gate node of the third light-emitting signal transistor.

7. The display device of claim 5, wherein, during the first period, the second light-emitting signal transistor is in a turn-on state, the low-level signal is supplied to the fourth node, and
during the first period, the second node is configured to receive the low-level signal, and the low-level signal is supplied to a gate node of the third light-emitting signal transistor.

8. The display device of claim 7, wherein, during a second period subsequent to the first period, the third light-emitting signal transistor and the fifth light-emitting signal transistor are in a turn-on state, and the low-level signal is supplied to the ninth node,
during the second period, the second light emission control signal line is configured to receive either the low-level signal or a first voltage having a voltage level higher than the low-level signal, and
the emission signal generation circuit is configured to supply, to the second light emission control signal line, the second light control signal at a level equal to the low-level signal or the first voltage.

9. The display device of claim 8, wherein, during the second period, the sixth node is configured to simultaneously receive the low-level signal supplied to the ninth node and the first light control signal, which is at a high-level, supplied to the first node, and
when the sixth node simultaneously receives the low-level signal supplied to the ninth node and the first light control signal supplied to the first node, the voltage level of the sixth node is the same as the low-level signal or the first voltage that is lower than the high-level of the first light control signal.

10. The display device of claim 9, wherein the fifth light-emitting signal transistor and the third light-emitting signal transistor each include a source region, a drain region, and a channel region disposed between the source region and the drain region, and
the channel region of the fifth light-emitting signal transistor has a greater width than that of the third light-emitting signal transistor.

11. The display device of claim 8, wherein, during a third period following the second period, the third, fourth, and fifth light-emitting signal transistors are in a turn-off state, and
the emission signal generation circuit is configured to output the second light control signal at a level equal to the low-level signal or a second voltage higher than the low-level signal, to the second light emission control signal line.

12. The display device of claim 11, wherein, during the third period, the third, fourth, and fifth light-emitting signal transistors are in a turn-off state, and the sixth node is electrically floating.

13. The display device of claim 11, wherein the first voltage is greater than the second voltage.

14. The display device of claim 11, wherein the first light control signal is at a low-level during the third period.

15. The display device of claim 11, wherein, during a fourth period following the third period,
the third light-emitting signal transistor is in a turn-on state, and the fourth and fifth light-emitting signal transistors are in a turn-off state, and
the emission signal generation circuit is configured to output the second light control signal, at a level about that of the first light control signal, to the second light emission control signal line during the fourth period.

16. The display device of claim 15, wherein the first light control signal is a high-level signal during the fourth period, and
the emission signal generation circuit is configured to supply the first light control signal, which is the high-level signal, to the sixth node electrically connected to the second light emission control signal line during the fourth period.

17. The display device of claim 3, wherein:
a gate node of the first light-emitting signal transistor is connected to be supplied with a high voltage maintained at a constant voltage level,
a gate node of the second light-emitting signal transistor is connected to be supplied with a first control signal having a voltage level varying over time,
a gate node of the fourth light-emitting signal transistor is connected to be supplied with a second control signal having a voltage level varying over time, and
a gate node of the fifth light-emitting signal transistor is connected to be supplied with a third control signal having a voltage level varying over time.

18. The display device of claim 17, further comprising a plurality of subpixels disposed in a matrix form of a plurality of rows and a plurality of columns, wherein:
a first subpixel is disposed in an n-th row;
a second subpixel is disposed in an (n+1)-th row, which is the row next to the n-th row; and
a third subpixel is disposed in an (n−a)-th row, which is a row preceding the n-th row, and
wherein n is a natural number and a is a natural number smaller than n.

19. The display device of claim 18, wherein the second control signal is a first scan signal for the (n−a)-th row supplied to the third subpixel, and
the third control signal is a second scan signal for the (n+1)-th row supplied to the second subpixel.

20. The display device of claim 19, wherein the first subpixel comprises:
a first transistor electrically connecting a first pixel node and a second pixel node, the gate pixel node being electrically connected to a third pixel node;
a second transistor electrically connecting the second pixel node and a driving voltage line, the gate pixel node being electrically connected to a first light emission control signal line carrying the first light control signal;
a third transistor electrically connecting the third pixel node and a data line, the gate pixel node being electrically connected to a first scan signal line supplying a first scan signal for the n-th row;
a fourth transistor electrically connecting the first pixel node and a fourth pixel node, the gate pixel node being electrically connected to a second light emission control signal line carrying the second light control signal;
a fifth transistor electrically connecting the third pixel node and a reference voltage line, the gate pixel node being electrically connected to a second scan signal line supplying a second scan signal for the n-th row;
a sixth transistor electrically connecting the fourth pixel node and a reset voltage line, the gate pixel node being electrically connected to a third scan signal line supplying a third scan signal;
a seventh transistor electrically connecting the first pixel node and an initialization voltage line, the gate pixel node being electrically connected to the third scan signal line supplying the third scan signal;
a first capacitor electrically connecting the first pixel node and the third pixel node;
a second capacitor electrically connecting the first pixel node and a direct current voltage line; and
a light emitting element electrically connecting the fourth pixel node and a base voltage line.

21. A display device comprising:
a first subpixel located in a display area and including a light emitting element;
a first light emission control signal line electrically connected to the first subpixel and configured to supply a first light control signal for controlling a light emission timing of the light emitting element;
a second light emission control signal line electrically connected to the first subpixel and configured to supply a second light control signal for controlling the light emission timing of the light emitting element; and
a gate driving circuit configured to supply the first light control signal to the first light emission control signal line and to supply the second light control signal to the second light emission control signal line, the gate driving circuit including:
a first transistor connected between the first light emission control signal line and the second light emission control signal line, a gate of the first transistor connected to the first light emission control signal line;
a second transistor connected between a logic high voltage source and the second light emission control signal line, a gate of the second transistor connected to a first scan signal line; and
a third transistor connected between a logic low voltage source and the second light emission control signal line, a gate of the third transistor connected to a second scan signal line.

22. The display device of claim 21, wherein a channel region of the third transistor has a greater width than that of the first transistor.

23. The display device of claim 21, wherein the gate driving circuit includes a fourth transistor connected between the gate of the first transistor and the logic low voltage source.
